(19) United States
(12) Patent Application Publication
(10) Pub. No.: US 2013/0155288 A1
(43) Pub. Date: Jun. 20, 2013

(54) IMAGING APPARATUS AND IMAGING METHOD

(71) Applicant: Samsung Electronics Co., Ltd., Gyeonggi-do (KR)

(72) Inventor: Masaru OKUDA, Kanagawa (JP)

(73) Assignee: Samsung Electronics Co., Ltd., Gyeonggi-do (KR)

(21) Appl. No.: 13/716,696

(22) Filed: Dec. 17, 2012

(30) Foreign Application Priority Data
Dec. 16, 2011 (JP) 2011276459
Nov. 14, 2012 (KR) 10-2012-0128979

(51) Int. Cl. H04N 5/262

(52) U.S. Cl. CPC H04N 5/2621
USPC 348/239

(57) ABSTRACT

An imaging apparatus and method are provided. A plurality of images is sequentially captured. It is determined whether one of the plurality of images includes a difference from a first reference image of the plurality of images. The one of the plurality of images is determined to be an initial image, when it is determined that the one of the plurality of images includes the difference from the first reference image. A portion of images from the plurality of images, which are captured after the initial image is captured, are extracted as an extracted image group. The extracted image group is combined.

### PRIORITY

This application claims priority under 35 U.S.C. §119(a) to Japanese Patent Application Serial No. 2011-276459, which was filed in the Japanese Patent Office on Dec. 16, 2011, and Korean Patent Application Serial No. 10-2012-0128979, which was filed in the Korean Patent Office on Nov. 14, 2012, the contents of which are incorporated herein by reference.

### BACKGROUND OF THE INVENTION

1. Field of the Invention

The present invention relates generally to an imaging apparatus and an imaging method, and more particularly, to generation of a combined image using an imaging apparatus.

2. Description of the Related Art

Current imaging apparatuses are capable of extracting a portion of each of a plurality of sequentially captured images, as an extracted image group, and connecting the extracted image group. For example, an imaging apparatus may successively capture a moving subject at the same point, cut out an extracted image from each captured image, and connect each extracted image in capturing time order in an direction opposite to that of a movement of the subject. The imaging apparatus may then display the combined image and time information on a display unit.

An instant image may be obtained that verifies the order of arrivals and that measures a time, without performing a process of developing a film. A time expended, while a racer leaves a start point and arrives a target point, is electronically determined. Thus, an expended time of each racer and the order of arrivals may be determined immediately after the race is completed. The extended time and the order of arrivals may be broadcasted in a TV broadcast without performing the process of developing a film.

However, a timing of initiating generation of a combined image is described as a time of pressing a shutter. Accordingly, the generation of the combined image is initiated regardless of a location of an object to be captured.

### SUMMARY OF THE INVENTION

The present invention has been made to address at least the above problems and/or disadvantages and to provide at least the advantages described below. Accordingly, an aspect of the present invention provides a method and apparatus for automatically initiating generation of a combined image based on a location of an object.

Another aspect of the present invention provides a method and apparatus for automatically terminating generation of a combined image based on a location of an object.

An additional aspect of the present invention provides a method and apparatus for generating a combined image in which a speed of an object is reflected.

A further aspect of the present invention provides a method and apparatus for generating a more natural combined image.

Another aspect of the present invention provides a method and apparatus for recognizing a time expended for capturing each portion.

In accordance with an aspect of the present invention, an imaging apparatus is provided that includes a capturing unit that sequentially captures a plurality of images. The imaging apparatus also includes an initiation verifying unit that determines whether one of the plurality of images includes a difference from a first reference image of the plurality of images. The imaging apparatus additionally includes an initial image determining unit that determines the one of the plurality of images to be an initial image, when the initiation verifying unit determines that the one of the plurality of images includes the difference from the first reference image. The imaging apparatus further includes an image extracting unit that extracts a portion of images from the plurality of images, which are captured after the initial image is captured, as an extracted image group, and a combining unit that combines the extracted image group.

In accordance with another aspect of the present invention, an imaging method is provided. A plurality of images is sequentially captured. It is determined whether one of the plurality of images includes a difference from a first reference image of the plurality of images. The one of the plurality of images is determined to be an initial image, when it is determined that the one of the plurality of images includes the difference from the first reference image. A portion of images from the plurality of images, which are captured after the initial image is captured, are extracted as an extracted image group. The extracted image group is combined.

In accordance with a further aspect of the present invention, an article of manufacture for an imaging method is provided. The article of manufacture includes a computer-readable storage medium storing one or more programs which when executed implement the steps of: sequentially capturing a plurality of images; determining whether one of the plurality of images includes a difference from a first reference image of the plurality of images; determining the one of the plurality of images to be an initial image, when it is determined that the one of the plurality of images includes the difference from the first reference image; extracting a portion of images from the plurality of images, which are captured after the initial image is captured, as an extracted image group; and combining the extracted image group.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a diagram illustrating a configuration of an imaging apparatus, according to an embodiment of the present invention;

FIG. 2 is a diagram illustrating a reference image that is used when an initiation verifying unit verifies initiation, according to an embodiment of the present invention;

FIG. 3 is a diagram illustrating verification with respect to initiation by an initiation verifying unit, according to an embodiment of the present invention;

FIG. 4 is a diagram illustrating a determination with respect to an initial image by an initial image determining unit, according to an embodiment of the present invention;

FIG. 5 is a diagram illustrating a direction of combination of an extracted image group extracted by an image extracting unit, according to an embodiment of the present invention;

FIG. 6 is a diagram illustrating calculation of a speed of a movement of an object used for extracting an extracted image group, according to an embodiment of the present invention;

FIG. 7 is a diagram illustrating extraction of an extracted image group based on a speed of an object, according to an embodiment of the present invention;

FIG. 8 is a diagram illustrating verification with respect to termination by a termination verifying unit, according to an embodiment of the present invention;

FIG. 9 is a diagram illustrating a combined image generated by a combining unit, according to an embodiment of the present invention; and

FIGS. 10A and 10B are flowchart illustrating operations of an imaging apparatus, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

According to embodiments of the present invention, generation of a combined image is automatically initiated based on a location of an object. Also, generation of a combined image is automatically terminated based on a location of an object. A combined image in which a speed of an object is reflected is generated. A more natural combined image is generated. A time expended for capturing each portion is readily recognized.

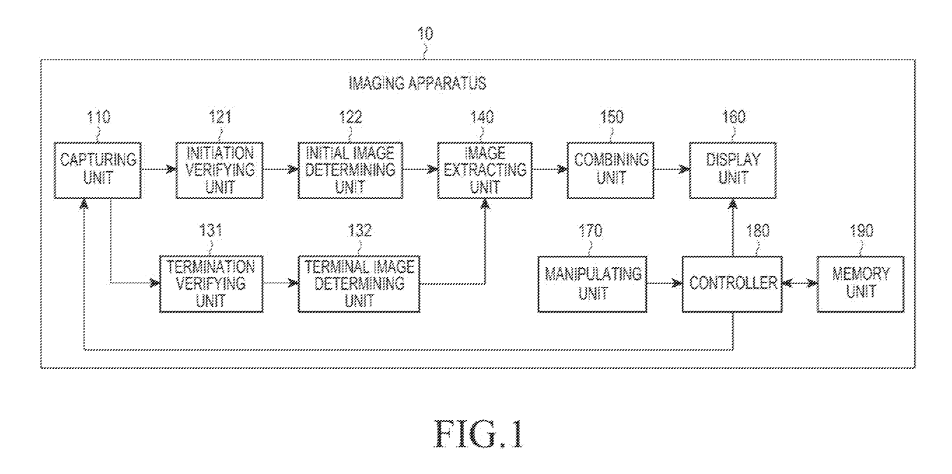

FIG. 1 is a diagram illustrating a configuration of an imaging apparatus 10, according to an embodiment of the present invention. As illustrated in FIG. 1, the imaging apparatus 10 includes a capturing unit 110, an initiation verifying unit 121, an initial image determining unit 122, a termination verifying unit 131, a terminal image determining unit 132, an image extracting unit 140, a combining unit 150, a display unit 160, a manipulating unit 170, a controller 180, and a memory unit 190.

The capturing unit 110 sequentially captures a plurality of images. Hereinafter, capturing is performed by the capturing unit 110 in an order of captured images Im0, Im1, . . . , and Im9. The capturing unit 110 includes, for example, an optical system that enables a light from a subject to penetrate so as to form an image on a capturing device. The capturing device performs photoelectric-conversion on light information associated with the incident light that penetrates a lens into an electric signal. The capturing device may be embodied as, for example, a Charge Coupled Device (CCD), or a Complementary Metal Oxide Semiconductor (CMOS).

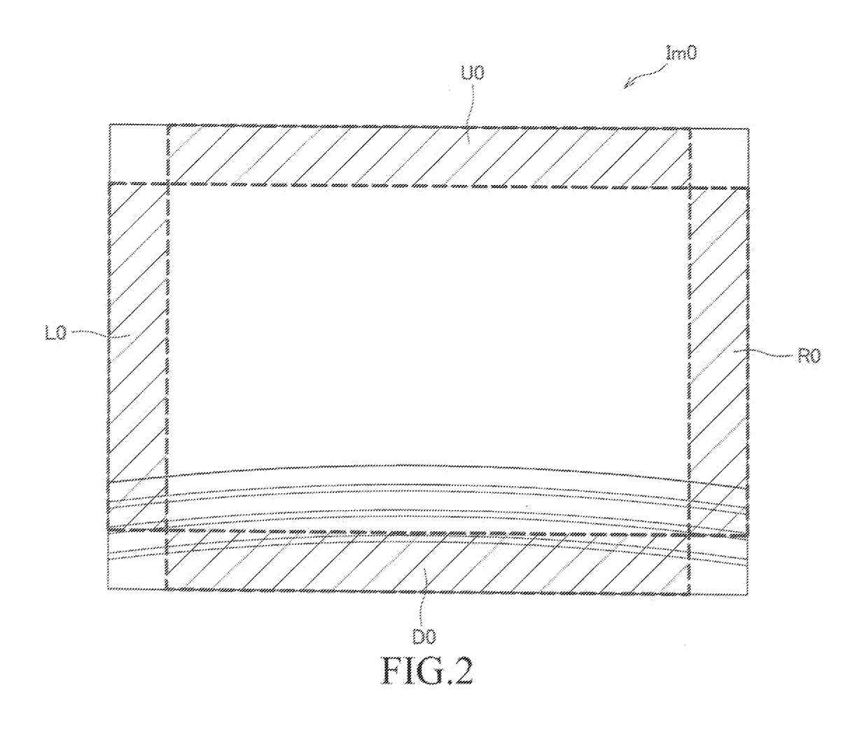

The initiation verifying unit 121 verifies whether an initial image is captured. The initial image determining unit 122 automatically determines the initial image based on a result of the verification of the initiation verifying unit 121. The termination verifying unit 131 verifies whether a terminal image is captured. The terminal image determining unit 132 automatically determines the terminal image based on a result of verification of the termination verifying unit 131. The image extracting unit 140 extracts a portion of each of images from the initial image to the terminal image. The combining unit 150 generates a combined image by combining an extracted image group, which will be described in detail with reference to FIGS. 2 through 9.

The display unit 160 displays, for example, an image before capturing (a live view), various screens for settings, a plurality of captured images sequentially captured by the capturing unit 110, a combined image generated from a plurality of captured images by the combining unit 150, and a combined image recorded in the memory unit 190. The display unit 160 may be embodied as, for example, a Liquid Crystal Display (LCD), an organic ElectroLuminescent (EL) display, or another display device.

The manipulating unit 170 corresponds to, for example, an up-down left-right key, a power switch, a mode dial, a shutter button, and the like, which are formed on the imaging apparatus 10. The manipulating unit 170 transmits a manipulation signal to the controller 180 based on manipulation by a user. For example, the shutter button may be half-pushed, fully-pushed, and released by the user. When the shutter button is half pushed, a manipulation signal for initiation of focus control is output. When the half pushing is released, a manipulation signal for termination of focus control is output. Also, when the shutter button is fully pushed, a manipulation signal for initiation of capturing is output.

The controller 180 functions as an operation processing device and a control device based on a program, and controls processing of each component element formed in the imaging apparatus 10. The controller 180 controls each component element of the imaging apparatus 10 based on a manipulation signal of the manipulating unit 170. Also, the controller 180 may be configured of only a Central Processing Unit (CPU), and may be configured of a plurality of CPUs, which process commands of a signaling system and a manipulation system.

The memory unit 190 corresponds to, for example, an optical disc such as a Compact Disc (CD), a Digital Versatile Disc (DVD), and a Blu-ray disc, an optical-magnetic disc, a magnetic disc, and a semi-conductor storage medium. The memory unit 190 may store a plurality of image data sequentially captured by the capturing unit 110. The memory unit 190 is also capable of storing a combined image generated by the combining unit 150. The memory unit 190 may be configured to be detachable from the imaging apparatus 10.

A series of processes processed by the imaging apparatus 10 may be processed by hardware, or may be processed by software based on a program included in a computer.

A function of each component element of the imaging apparatus 10 is described in greater detail below, according to an embodiment of the present invention.

FIG. 2 is a diagram illustrating a reference image that is used when the initiation verifying unit 121 verifies initiation, according to an embodiment of the present invention. The initiation verifying unit 121 verifies whether a captured image including a difference from a first reference image is captured by the capturing unit 120. The first reference image may not be limited to a predetermined image, and may include, for example, a captured image when a shutter button is pressed or an image captured at a previous time.

FIG. 2 illustrates a situation in which a captured image Im0, which is captured when the shutter button is pressed, is used as the first reference image. A method of verifying whether a captured image including a difference is captured by the capturing unit 110 may not be limited to a predetermined method.

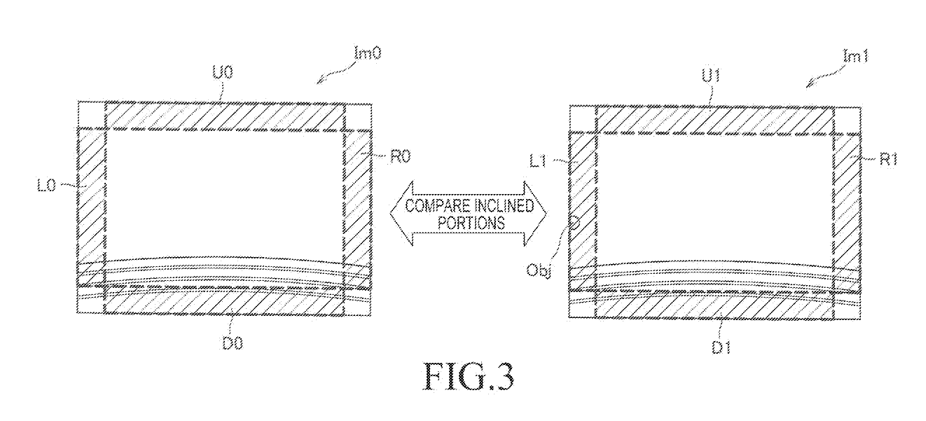

FIG. 3 is a diagram illustrating verification with respect to initiation by the initiation verifying unit 121, according to an embodiment of the present invention.

FIG. 3 illustrates a captured image Im1, which is captured after the shutter is pressed, as an example of a captured image that is captured at a current time.

The initiation verifying unit 121 verifies, for example, whether a difference exists between a left image L0 set on the first reference image Im0 and a left image L1 set on the captured image Im1 captured at the current time. Accordingly, it may be verified whether a captured image including a difference in a left image is captured by the capturing unit 110. In the same manner, the initiation verifying unit 121 may verify, for example, whether a difference exists between an upper image U0 and an upper image U1. Accordingly, it may be verified whether a captured image including a difference in an upper image is captured by the capturing unit 110.

In the same manner, the initiation verifying unit 121 may verify, for example, whether a difference exists between a right image R0 and a right image R1. Accordingly, it may be verified whether a captured image including a difference in a right image is captured by the capturing unit 110. In the same manner, the initiation verifying unit 121 may verify, for example, whether a difference exists between a lower image DO and a lower image D1. Accordingly, it may be verified whether a captured image including a difference in a lower image is captured by the capturing unit 110 may be verified. A method of verifying whether a difference exists may not be limited to a predetermined method, and, for example, a template matching scheme and the like may be applied for verifying whether a difference exits.

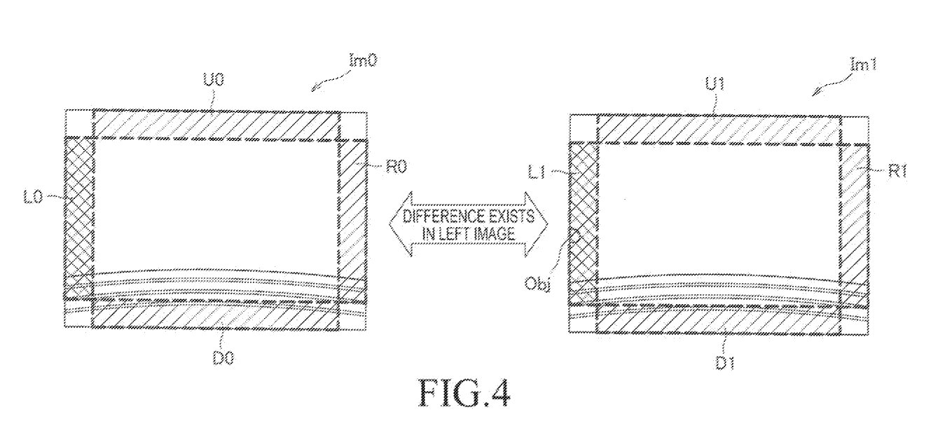

FIG. 4 is a diagram illustrating a determination with respect to an initial image by an initial image determining unit, according to an embodiment of the present invention. A difference occurs between a left image L0 and a left image L1 since an object Obj appears on the left image L1 of the captured image Im1. Accordingly, the initiation verifying unit 121 verifies that a captured image including a difference in a left image is captured by the capturing unit 110. Also, the initiation verifying unit 121 verifies a direction of a combination of an extracted image group extracted by the image extracting unit 140.

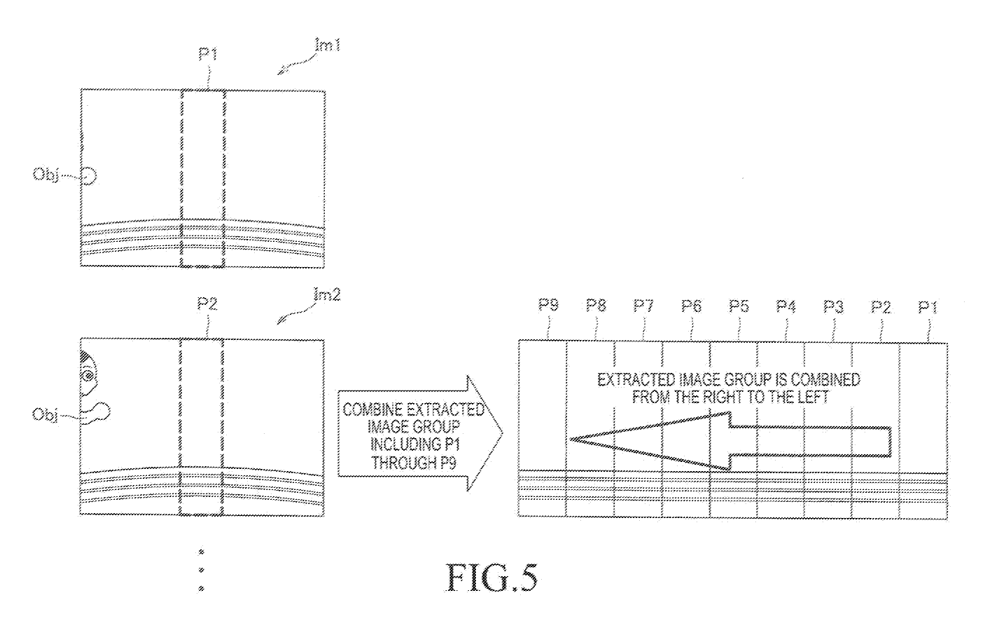

FIG. 5 is a diagram illustrating a direction of a combination of an extracted image group extracted by the image extracting unit 140, according to an embodiment of the present invention. An extracted image group P1 through P9 are combined.

Referring back to FIG. 4, the initiation verifying unit 121 verifies that the captured image including the difference in the left image is captured by the capturing unit 110. The object Obj is expected to move to the right. Accordingly, the initiation verifying unit 121 determines a direction of combination of an extracted image group to be to the left, which is opposite a direction of a movement of the object Obj. In the same manner, the initiation verifying unit 121 may determine the direction of a combination of the extracted image group is a direction associated with a direction of a movement of an object reflected on an initial image. For example, the initiation verifying unit 121 may determine the direction of the combination of the extracted image group to be opposite to the direction of the movement of the object.

However, a method of verifying a direction of a combination of an extracted image group may not be limited to a predetermined method. Also, a method of detecting a direction of a movement of an object reflected on an initial image may not be limited to a predetermined method. For example, when a direction of a movement of an object reflected on an initial image is detected through any method, the initiation verifying unit 121 may determine a direction of a combination of an extracted image group to be a direction associated with the direction of the movement. The initiation verifying unit 121 may detect a direction of a movement of an object based on a location of an object reflected on an initial image and a location of an object reflected on a previous or subsequent captured image of the initial image.

The initiation verifying unit 121 may determine a shape of an extracted image group to be a shape associated with a direction of a movement of an object reflected on an initial image. For example, the initiation verifying unit 121 may determine the shape of the extracted image group to be a globular shape that is long in the vertical direction against the direction of the movement of the object (in particular, a globular shape that is longer in the vertical direction when compared to a direction of a movement). Referring back to FIG. 4, a direction of a movement of the object Obj is detected to be to the right and thus, the initiation verifying unit 121 determines the shape of the extracted image group to be a globular shape that is long in the vertical direction with respect to the right (in particular, a globular shape that is longer in the vertical direction when compared to the horizontal direction).

When the initiation verifying unit 121 verifies that a captured image, which includes a difference from the first reference, is captured, the initial image determining unit 122 determines the corresponding captured image to be an initial image. The image extracting unit 140 extracts, as an extracted image group, a portion of each of a plurality of captured images captured by the capturing unit 110 after the initial image is captured. A location of each portion extracted by the image extracting unit 140 may not be limited to a predetermined location. Also, a size of each portion extracted by the image extracting unit 140 may not be limited to a predetermined size. For example, the image extracting unit 140 may extract the extracted image group so that a size of each portion of the extracted image group corresponds to a size associated with a speed of an object reflected on the initial image.

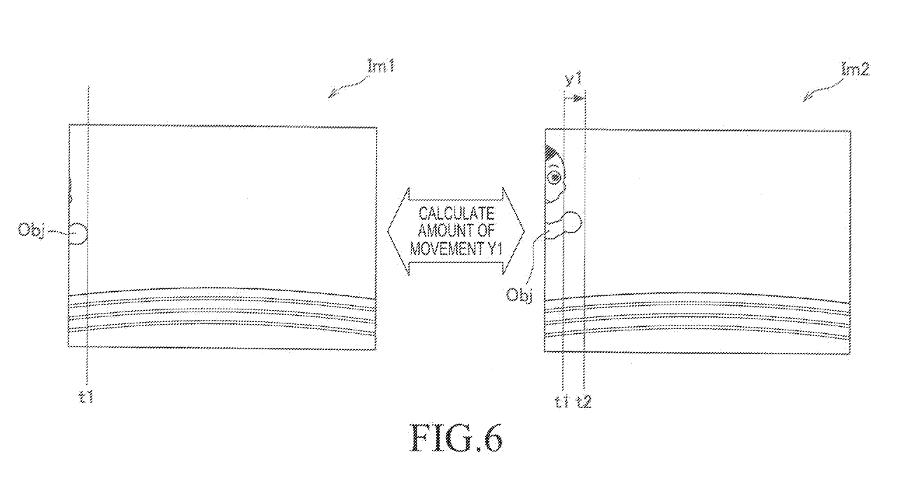

FIG. 6 is a diagram illustrating calculation of a speed of an object used for extracting an extracted image group, according to an embodiment of the present invention. The image extracting unit 140 calculates an amount of movement y1 of the object Obj based on an interval between a location of the object Obj reflected on the captured image Im1 (a location at t1) and a location of the object Obj reflected on a captured image Im2 (a location at t2). In this example, the image extracting unit 140 may calculate a speed of the movement of the object Obj based on y1/(t2−t1). However, a method of calculating a speed of a movement of an object may not be limited to a predetermined method. Also, a phase-only correlation may be applicable for calculation of the amount of movement y1 of the object Obj.

The image extracting unit 140 may extract the extracted image group so that a size of each portion of the extracted image group corresponds to a size associated with a speed of an object.

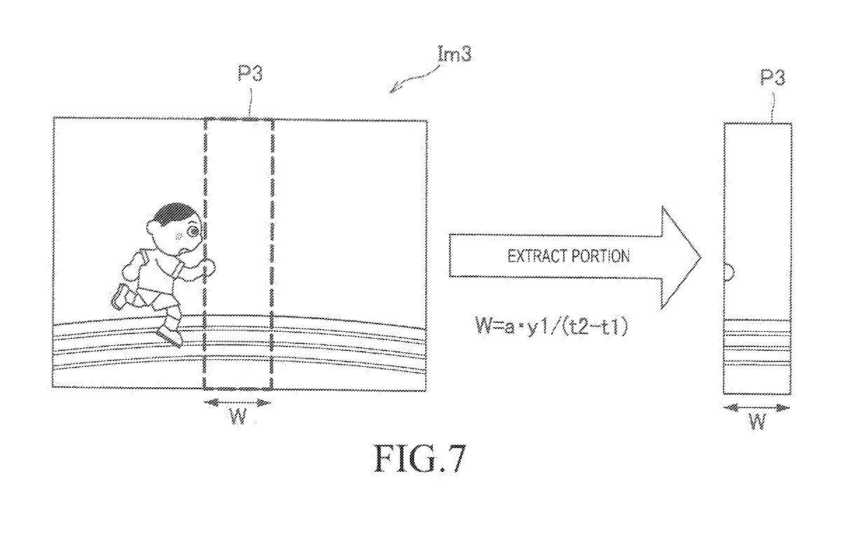

FIG. 7 is a diagram illustrating extraction of an extracted image group based on a speed of a movement of an object, according to an embodiment of the present invention. The image extracting unit 140 may enable a size of each portion to be larger when a speed of an object is higher. For example, a length of a direction of a combination of respective extracted images may be enabled to be longer. Referring to FIG. 7, an extracted image group is extracted to enable a width W of each extracted image to be equal to a value of a product of a constant “a” and y1/(t2−t1), which corresponds to a speed of the object Obj. FIG. 7 illustrates an extracted image P3, as a portion of the extracted image group.

The image extracting unit 140 may extract the extracted image group to enable a capturing interval of each portion of the extracted image group to be a value associated with a speed of an object reflected on an initial image. For example, the image extracting unit 140 may enable the capturing interval of each portion to be smaller as y1/(t2−t1) corresponding to the speed of the object Obj is higher. Thus, a frame rate of each portion is enabled to be higher. For example, the image extracting unit 140 extracts the extracted image group to enable the frame rate of each portion to be equal to a value of a product of a constant “b” and y1/(t2−t1) corresponding to the speed of the object Obj.

Although it has been described that each portion of a plurality of captured images captured by the capturing unit 110 is extracted as an extracted image group by the image extracting unit 140 after an initial image is captured, termination may be determined in an extracted image. The termination verifying unit 131 verifies whether a captured image that does not include a difference from a second reference image is captured by the capturing unit 110. The second reference image may not be limited to a predetermined image, and may include a captured image that is captured when a shutter button is pressed or a captured image captured at a previous time.

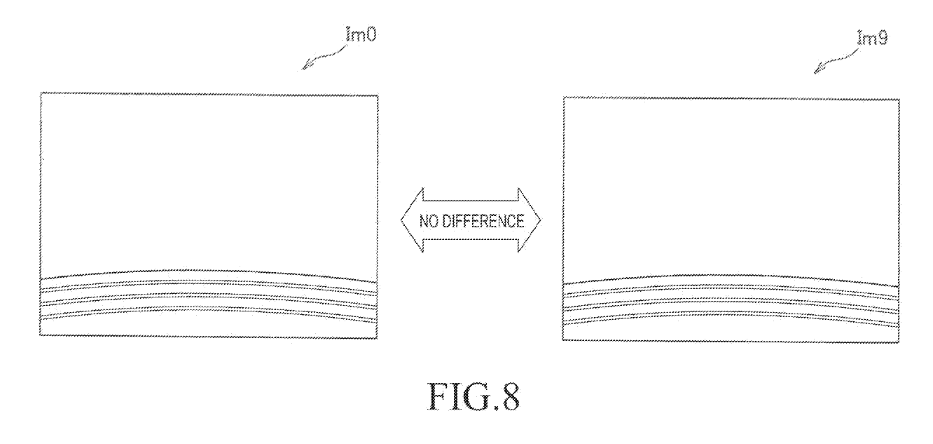

FIG. 8 is a diagram illustrating verification with respect to termination by the termination verifying unit 131, according to an embodiment of the present invention. FIG. 8 illustrates a case in which the captured image Im0 captured when the shutter button is pressed is used as a second reference image. A method of verifying whether a captured image that does not include a difference is captured by the capturing unit 110 (a termination verifying method) may not be limited to a predetermined method. FIG. 8 illustrates a captured image Im9 as an example of a captured image captured at a current time. The termination verifying unit 131 verifies whether a difference exists between the captured image Im0 and the captured image Im9. Accordingly, it may be verified whether a captured image that does not include a difference is captured by the capturing unit 110.

Referring to FIG. 8, a difference disappears between the captured image Im0 and the captured image Im9 since the object Obj is not reflected on the captured image Im9. Accordingly, the termination verifying unit 131 may verify that the captured image Im9 that does not include a difference is captured by the capturing unit 110. When the termination verifying unit 131 verifies that a captured image that does not include a difference from the second reference image is captured, the terminal image determining unit 132 determines the corresponding captured image to be a terminal image.

In the same manner, when the terminal image is determined by the terminal image determining unit 132, the image extracting unit 140 extracts an extracted image group configured of a portion of each of a plurality of captured images captured by the capturing unit 110 after the initial image is captured and before the terminal is captured. For example, when the captured image Im1 is determined to be the initial image by the initial image determining unit 122 and the captured image Im9 is determined to be the terminal image by the terminal image determining unit 132, the image extracting unit 140 extracts the extracted image group P1 through P9 from the captured image Im1 through Im9.

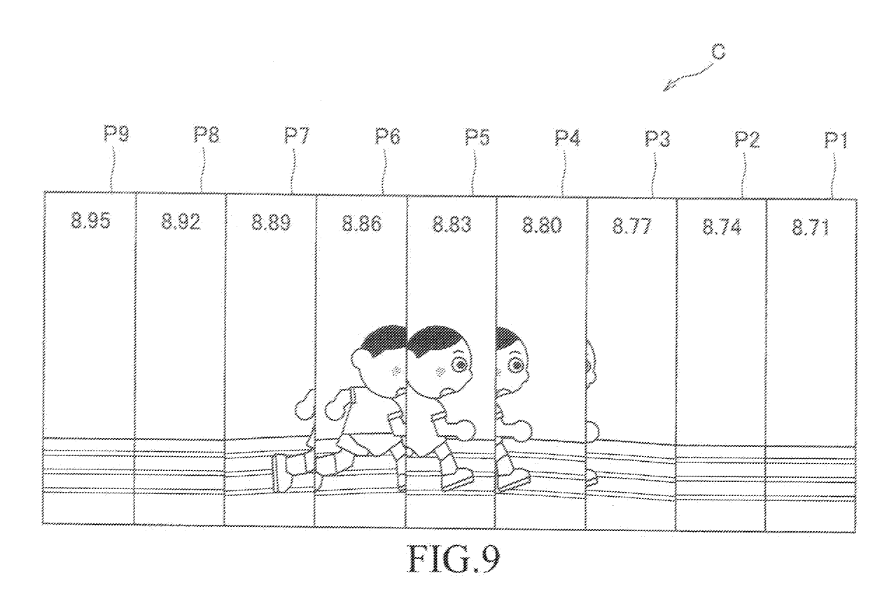

FIG. 9 is a diagram illustrating a combined image generated by the combining unit 150, according to an embodiment of the present invention. The combining unit 150 combines an extracted image group extracted by the image extracting unit 140. As illustrated in FIG. 9, the combining unit 150 generates a combined image C by combining an extracted image group including P1 through P9 extracted by the image extracting unit 140. The combining unit 150 may correlate each capturing time with a corresponding portion of the extracted image group. In this example, the display unit 160 displays the combined image obtained by combining the extracted image group through the combining unit 150 and displays each capturing time.

A reference time for each capturing time is not limited to a predetermined time, and a time of pressing a shutter button for initiating capturing of an image by the capturing unit 110 may be used as a reference. FIG. 9 illustrates an example in which the display unit 160 displays the combined image C and each capturing time. Each capturing time is provided as a capturing time ┌8.71┘ of an extracted image P1, a capturing time ┌8.74┘ of an extracted image P2, a capturing time ┌8.77┘ of an extracted image P3, a capturing time ┌8.80┘ of an extracted image P4, a capturing time ┌8.83┘ of an extracted image P5, a capturing time ┌8.86┘ of an extracted image P6, a capturing time ┌8.89┘ of an extracted image P7, a capturing time ┌8.92┘ of an extracted image P8, and a capturing time ┌8.95┘ of an extracted image P9.

Although FIG. 9 illustrates a unit of each capturing time as in seconds, this may not be limited thereto. Also, FIG. 9 illustrates each capturing time at regular intervals, but the interval corresponds to a length adjusted based on a size of each portion of an extracted image group. Also, the extracted image group and each capturing time correlated as described in the foregoing may be stored in the memory unit 190 based on controlling of the controller 180. The controller 180 may display each capturing time when the extracted image group stored in the memory unit 190 is played back.

Also, the memory unit 190 may store a size of each portion. In this example, the controller 180 may display each capturing time at intervals adjusted based on the size of each portion when the extracted image group stored in the memory unit 190 is played back. An area where each capturing time and the size of each portion are stored may not be limited to a predetermined area, and may include, for example, an image file configuring the extracted image group. For example, when a format of the image file corresponds to an Exchangeable Image File Format (Exif), each capturing time and a size of each portion may be recorded in a MakerNote portion.

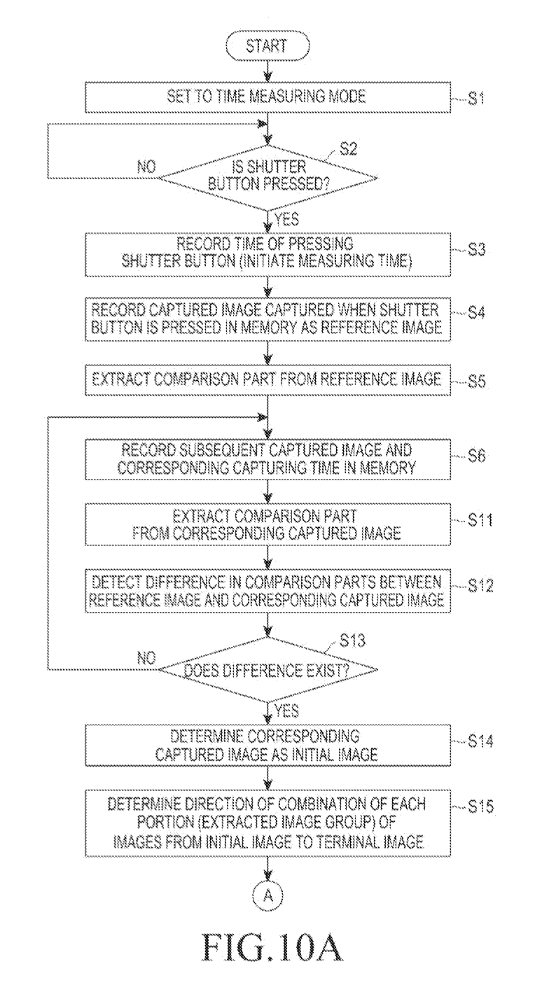

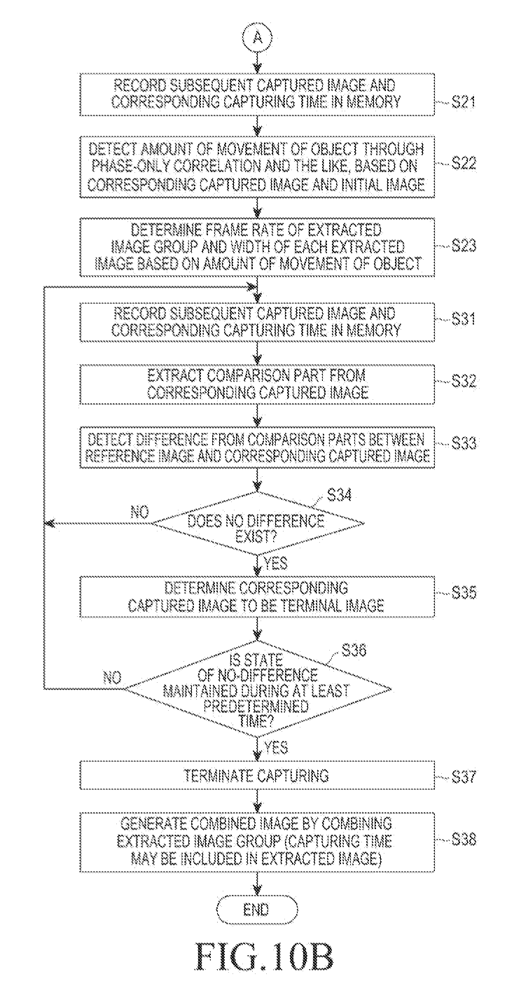

A function of each component element of the imaging apparatus 10, according to an embodiment of the present invention, has been described. Hereinafter, operations of the imaging apparatus 10, according to an embodiment of the present invention will be described. FIGS. 10A and 10B illustrate a flowchart having operations of the imaging apparatus 10. Also, the flow of the operations of the imaging apparatus 10 illustrated in FIGS. 10A and 10B is merely an example and thus, the flow of the operations of the imaging apparatus 10 may not be limited thereto.

As illustrated in FIG. 10A, the controller 180 sets a current mode to a time measuring mode based on a manipulation signal from the manipulating unit 170, in step S1. A frame rate and the like may be high within a scope where generation of a combined image is not affected. Subsequently, the controller 180 verifies whether a shutter button is pressed, in step S2. When it is verified that the shutter button is not pressed, the controller 180 returns to step S2. When it is verified that the shutter button is pressed, the controller 180 records a time of pressing the shutter button in a memory, in step S3. Therefore, measuring time is initiated. The memory corresponds to, for example, the memory unit 190.

Subsequently, the controller 180 records, in the memory, a captured image, which is captured when the shutter is pressed, as a reference image, in step S4. The reference image may be equivalent to a first reference image, as described above in FIG. 2. Subsequently, the initiation verifying unit 121 extracts, from the reference image, a comparison part to be compared, in step S5. The comparison part corresponds to images of four edges (a left image, a right image, an upper image, and a lower image) set on the reference image, as described above in FIG. 2. The controller 180 records, in the memory, a subsequent captured image and a corresponding capturing time, in step S6. The initiation verifying unit 121 extracts, from the corresponding captured image, a comparison part to be compared in step S11. The comparison part corresponds to images of four edges (a left image, a right image, an upper image, and a lower image) set on the captured image, as described above in FIG. 3.

The initiation verifying unit 121 determines whether there is a difference in the comparison parts between the reference image and the corresponding captured image, in step S12. Detection of the difference may be performed with respect to, for example, each of the images of the four edges. As described above, a template matching scheme and the like may be applicable for the detection of the difference. The initiation verifying unit 121 verifies whether a difference exists in the comparison parts between the reference image and the corresponding captured image, in step S13. Whether the difference exists may be verified based on, for example, whether a difference exists in, for example, any of the images of the four edges.

When it is verified that the difference does not exist, the initial image determining unit 122 returns to step S6. When it is verified that the difference exists, the initial image determining unit 122 determines the corresponding captured image to be an initial image, in step S14, and the initiation verifying unit 121 determines a direction of combination of each portion of images (an extracted image group) from the initial image to a terminal image, in step S15. In this embodiment of the present invention, the initiation verifying unit 121 may determine a shape of the extracted image group. Determining the direction of the combination of the extracted image group or the shape of the extracted image group may be embodied as described above.

Referring now to FIG. 10B, subsequently, the controller 180 records, in the memory, a subsequent captured image and a corresponding capturing time, in step S21. The image extracting unit 140 detects an amount of movement of an object through a phase-only correlation and the like, based on the corresponding captured image and the initial image, in step S22. The image extracting unit 140 determines a frame rate of the extracted image group and a width of each extracted image, based on the amount of movement of the object, in step S23. In an embodiment of the present invention, the frame rate of the extracted image group corresponds to a capturing interval of each portion configuring the extracted image group, and the width of each extracted image corresponds to a size of each portion.

Subsequently, the controller 180 records, in the memory, a subsequent captured image and a corresponding capturing time, in step S31. The termination verifying unit 131 extracts, from the corresponding captured image, a comparison part to be compared, in step S32. The comparison part corresponds to images of four edges (a left image, a right image, an upper image, and a lower image) set on the captured image, as described above. The termination verifying unit 131 determines whether there is a difference in the comparison parts between the reference image and the corresponding captured image, in step S33. Detection of the difference may be performed with respect to, for example, each of the images of the four edges. Also, as described above, a template matching scheme and the like may be applicable to the detection of the difference.

The termination verifying unit 131 verifies whether the difference exists in the comparison parts between the reference image and the corresponding captured image, in step S34. Whether the difference exists may be verified based on, for example, whether a difference exists in any portion of the entire captured image. The reference image corresponds to the second reference image described above.

When it is verified that the difference exists, the terminal image determining unit 132 returns to step S31. When it is verified that the difference does not exist, the terminal image determining unit 132 determines the corresponding captured image to be a terminal image, in step S35. The controller 180 verifies whether a state of no-difference is maintained during at least a predetermined time, in step S36.

When the state of no-difference is not maintained during the at least a predetermined time, the controller 180 returns to step S31. When the state of no-difference is maintained during the at least a predetermined time, the controller 180 terminates capturing by the capturing unit 110, in step S37. The combining unit 150 generates a combined image by combining the extracted image group, in step S38. In this embodiment of the present invention, a capturing time may be included in an extracted image. Also, when the captured images from the initial image to the terminal image are sequentially recorded in the memory, the extracted image group may be extracted from the captured images before the combined image is generated, or may be recorded in the memory in a state where the extracted image group is extracted as the extracted image group. Also, a capturing time and a size of each portion of the extracted image group may be recorded in the memory.

The imaging apparatus 10, according to an embodiment of the present invention is configured to include the capturing unit 110 to sequentially capture a plurality of images. The imaging apparatus 10 also includes the initiation verifying unit 121 to verify whether a captured image including a difference from a first reference image is captured. The imaging apparatus 10 additionally includes the initial image determining unit 122 to determine, to be an initial image, the captured image when it is verified that the captured image including the difference from the first reference image is captured. The imaging apparatus 10 further includes the image extracting unit 140 to extract, as an extracted image group, a portion of each of the plurality of captured images captured after the initial image is captured. The imaging apparatus also includes the combining unit 150 to combine the extracted image group. The configuration may enable generation of a combined image to be automatically initiated based on a location of an object.

While the present invention has been shown and described with reference to certain embodiments thereof, it will be understood by those skilled in the art that various changes in form and detail may be made therein without departing from the spirit and scope of the present invention as defined by the appended claims.

What is claimed is:

1. An imaging apparatus comprising:
a capturing unit that sequentially captures a plurality of images;
an initiation verifying unit that determines whether one of the plurality of images includes a difference from a first reference image of the plurality of images;
an initial image determining unit that determines the one of the plurality of images to be an initial image, when the initiation verifying unit determines that the one of the plurality of images includes the difference from the first reference image;
an image extracting unit that extracts a portion of images from the plurality of images, which are captured after the initial image is captured, as an extracted image group; and
a combining unit that combines the extracted image group.

2. The apparatus of claim 1, further comprising:
a termination verifying unit that determines whether another of the plurality of images after the initial image does not include a difference from a second reference image of the plurality of images; and
a terminal image determining unit that determines the other of the plurality of images to be a terminal image when the termination verifying unit determines that the other of the plurality of images does not include the difference from the second reference image,
wherein the image extracting unit extracts the extracted image group configured of a portion of each of the images, which are captured after the initial image is captured and before the terminal image is captured.

3. The apparatus of claim 2, wherein the image extracting unit extracts the extracted image group so that a size of each portion is associated with a speed of an object reflected on the initial image.

4. The apparatus of claim 2, wherein the image extracting unit extracts the extracted image group so that a capturing interval of each portion is associated with a speed of an object reflected on the initial image.

5. The apparatus of claim 2, wherein the combining unit combines the extracted image group in a direction determined based on a direction of a movement of an object reflected on the initial image.

6. The apparatus of claim 2, wherein the combining unit correlates each portion with a corresponding capturing time based on a time a shutter button is pressed to initiate capturing by the capturing unit.

7. The apparatus of claim 6, further comprising:
a display unit that displays a combined image obtained by combining the extracted image group at the combining unit, and that displays each capturing time.

8. An imaging method comprising the steps of:
sequentially capturing a plurality of images;
determining whether one of the plurality of images includes a difference from a first reference image of the plurality of images;
determining the one of the plurality of images to be an initial image, when it is determined that the one of the plurality of images includes the difference from the first reference image;
extracting a portion of images from the plurality of images, which are captured after the initial image is captured, as an extracted image group; and
combining the extracted image group.

9. The method of claim 8, further comprising:
determining whether another of the plurality of images after the initial image does not include a difference from a second reference image of the plurality of images; and
determining the other of the plurality of images to be a terminal image when it is determined that the other of the plurality of images does not include the difference from the second reference image,
wherein the extracted image group is configured of the portion of each of the images, which are captured after the initial image is captured and before the terminal image is captured.

10. The method of claim 9, wherein the extracted image group is extracted so that a size of each portion is associated with a speed of an object reflected on the initial image.

11. The method of claim 9, wherein the extracted image group is extracted so that a capturing interval of each portion is associated with a speed of an object reflected on the initial image.

12. An article of manufacture for an imaging method, comprising a computer-readable storage medium storing one or more programs which when executed implement the steps of:
sequentially capturing a plurality of images;
determining whether one of the plurality of images includes a difference from a first reference image of the plurality of images;
determining the one of the plurality of images to be an initial image, when it is determined that the one of the plurality of images includes the difference from the first reference image;
extracting a portion of images from the plurality of images, which are captured after the initial image is captured, as an extracted image group; and
combining the extracted image group.
